(19) United States
(12) Patent Application Publication
(10) Pub. No.: US 2026/0112727 A1
(43) Pub. Date: Apr. 23, 2026

(54) CONFIGURATIONS FOR INTERFACE BETWEEN BATTERY ARRAY AND THERMAL EXCHANGE PLATE

(71) Applicant: Ford Global Technologies, LLC, Dearborn, MI (US)

(72) Inventors: Eric Poirier, Brownstown, MI (US); Ahalya Srikanth, Lasalle (CA); Daniel Roberts, Livonia, MI (US); Masahiro Kimoto, Plymouth, MI (US); Daryl Arnell Marlow, Dearborn, MI (US)

(21) Appl. No.: 18/918,218

(22) Filed: Oct. 17, 2024

(51) Int. Cl. H01M 10/653; H01M 10/625; H01M 10/651; H01M 10/6554

(52) U.S. Cl. CPC H01M 10/653; H01M 10/625; H01M 10/651; H01M 10/6554

(57) ABSTRACT

This disclosure relates generally to electrified vehicles, and more specifically relates to configurations for the interface between a battery array and a thermal exchange plate. In an example, a battery pack may include a battery array, a thermal exchange plate, and an interface between the battery array and the thermal exchange plate. The interface is configured to reduce capacitance between the battery array and the thermal exchange plate.

### TECHNICAL FIELD

This disclosure relates generally to electrified vehicles, and more specifically relates to configurations for the interface between a battery array and a thermal exchange plate.

### BACKGROUND

A high voltage traction battery pack typically powers the electric machines and other electrical loads of an electrified vehicle. The traction battery pack includes a plurality of battery cells.

### SUMMARY

In some aspects, the techniques described herein relate to a battery pack, including: a battery array; a thermal exchange plate; and an interface between the battery array and the thermal exchange plate configured to reduce capacitance between the battery array and the thermal exchange plate.

In some aspects, the techniques described herein relate to a battery pack, wherein the interface includes: a layer of thermal interface material disposed between the battery array and the thermal exchange plate; and a layer of dielectric material disposed between the thermal exchange plate and the layer of thermal interface material.

In some aspects, the techniques described herein relate to a battery pack, wherein the layer of dielectric material is a provided by a coating applied to the thermal exchange plate.

In some aspects, the techniques described herein relate to a battery pack, wherein: the interface includes a layer of dielectric material disposed between the battery array and the thermal exchange plate, and the layer of dielectric material exhibits a thickness and a dielectric constant configured to reduce capacitance between the battery array and the thermal exchange plate.

In some aspects, the techniques described herein relate to a battery pack, wherein the thickness is within a range of 25 μm and 250 μm, and the dielectric constant is less than 3.

In some aspects, the techniques described herein relate to a battery pack, wherein the dielectric constant is within a range of 3 and 7, and the thickness is greater than 250 μm.

In some aspects, the techniques described herein relate to a battery pack, wherein the layer of dielectric material is a provided by a coating applied to the thermal exchange plate.

In some aspects, the techniques described herein relate to a battery pack, wherein the interface does not include any thermal interface material.

In some aspects, the techniques described herein relate to a battery pack, wherein the interface consists of the layer of dielectric material.

In some aspects, the techniques described herein relate to a battery pack, wherein: the battery array includes a plurality of battery cells, each of the plurality of battery cells includes a housing having a bottom wall, and the interface is between the bottom walls of the battery cells and the thermal exchange plate.

In some aspects, the techniques described herein relate to a battery pack, wherein the battery array is one of a plurality of battery arrays within the battery pack.

In some aspects, the techniques described herein relate to a battery pack, wherein the battery pack is a battery pack of an electrified vehicle.

In some aspects, the techniques described herein relate to an electrified vehicle, including: a battery pack including a battery array, a thermal exchange plate, and an interface between the battery array and thermal exchange plate, wherein the interface includes either: (i) a layer of thermal interface material disposed between the battery array and the thermal exchange plate, and a layer of dielectric material disposed between the thermal exchange plate and the layer of thermal interface material, or (ii) a layer of dielectric material disposed between the battery array and the thermal exchange plate, wherein the layer of dielectric material exhibits a thickness and a dielectric constant according to one of the following: (a) the thickness is within a range of 25 μm and 250 μm, and the dielectric constant is less than 3, or (b) the dielectric constant is within a range of 3 and 7, and the thickness is greater than 250 μm.

In some aspects, the techniques described herein relate to an electrified vehicle, wherein the interface includes: a layer of thermal interface material disposed between the battery array and the thermal exchange plate; and a layer of dielectric material disposed between the thermal exchange plate and the layer of thermal interface material.

In some aspects, the techniques described herein relate to an electrified vehicle, wherein: the interface includes a layer of dielectric material disposed between the battery array and the thermal exchange plate, and the layer of dielectric material exhibits a thickness within a range of 25 μm and 250 μm and further exhibits a dielectric constant less than 3.

In some aspects, the techniques described herein relate to an electrified vehicle, wherein: the interface includes a layer of dielectric material disposed between the battery array and the thermal exchange plate, and the layer of dielectric material the exhibits a dielectric constant within a range of 3 and 7, and further exhibits a thickness greater than 250 μm.

In some aspects, the techniques described herein relate to an electrified vehicle, wherein the interface does not include any thermal interface material.

In some aspects, the techniques described herein relate to an electrified vehicle, wherein the interface consists of the layer of dielectric material.

In some aspects, the techniques described herein relate to a method, including: establishing an interface between a battery array and a thermal exchange plate, wherein the wherein the interface includes either: (i) a layer of thermal interface material disposed between the battery array and the thermal exchange plate, and a layer of dielectric material disposed between the thermal exchange plate and the layer of thermal interface material, or (ii) a layer of dielectric material disposed between the battery array and the thermal exchange plate, wherein the layer of dielectric material exhibits a thickness and a dielectric constant according to one of the following: (a) the thickness is within a range of 25 μm and 250 μm, and the dielectric constant is less than 3, or (b) the dielectric constant is within a range of 3 and 7, and the thickness is greater than 250 μm.

In some aspects, the techniques described herein relate to a method, wherein the interface consists of the layer of dielectric material, and wherein the dielectric layer is provided by a coating applied to the thermal exchange plate.

### BRIEF DESCRIPTION OF THE DRAWINGS

FIG. 1 schematically illustrates a powertrain of an electrified vehicle.

FIG. 2 illustrates a battery pack of an electrified vehicle.

FIG. 3 illustrates a first example configuration for an interface between a battery array and a thermal exchange plate.

FIG. 4 illustrates a second example configuration for an interface between a battery array and a thermal exchange plate.

### DETAILED DESCRIPTION

This disclosure relates generally to electrified vehicles, and more specifically relates to configurations for the interface between a battery array and a thermal exchange plate. An example interface between a battery array and a thermal exchange plate is configured to reduce capacitance between the battery array and the thermal exchange plate (such capacitance may be referred to as parasitic or stray capacitance). These and other benefits will be appreciated from the following description.

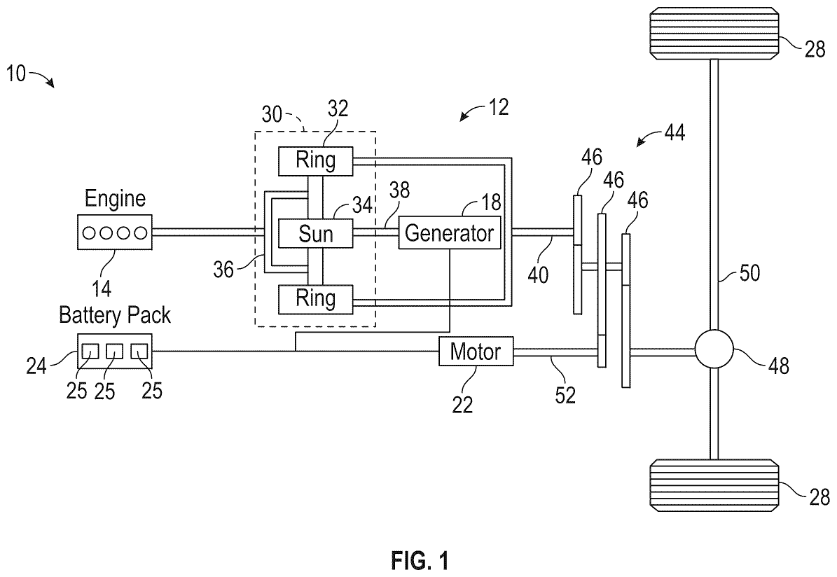

FIG. 1 schematically illustrates a powertrain 10 for an electrified vehicle 12. Although depicted as a hybrid electric vehicle (HEV), it should be understood that the concepts described herein are not limited to HEVs and could extend to other electrified vehicles, including, but not limited to, plug-in hybrid electric vehicles (PHEVs), battery electric vehicles (BEVs), fuel cell vehicles, etc.

In an embodiment, the powertrain 10 is a power-split powertrain system that employs first and second drive systems. The first drive system includes a combination of an engine 14 and a generator 18 (i.e., a first electric machine). The second drive system includes at least a motor 22 (i.e., a second electric machine), the generator 18, and a battery pack 24. In this example, the second drive system is considered an electric drive system of the powertrain 10. The first and second drive systems are each capable of generating torque to drive one or more sets of vehicle drive wheels 28 of the electrified vehicle 12. Although a power-split configuration is depicted in FIG. 1, this disclosure extends to any hybrid or electric vehicle including full hybrids, parallel hybrids, series hybrids, mild hybrids, or micro hybrids.

The engine 14, which may be an internal combustion engine, and the generator 18 may be connected through a power transfer unit 30, such as a planetary gear set. Of course, other types of power transfer units, including other gear sets and transmissions, may be used to connect the engine 14 to the generator 18. In a non-limiting embodiment, the power transfer unit 30 is a planetary gear set that includes a ring gear 32, a sun gear 34, and a carrier assembly 36.

The generator 18 can be driven by the engine 14 through the power transfer unit 30 to convert kinetic energy to electrical energy. The generator 18 can alternatively function as a motor to convert electrical energy into kinetic energy, thereby outputting torque to a shaft 38 connected to the power transfer unit 30. Because the generator 18 is operatively connected to the engine 14, the speed of the engine 14 can be controlled by the generator 18.

The ring gear 32 of the power transfer unit 30 may be connected to a shaft 40, which is connected to vehicle drive wheels 28 through a second power transfer unit 44. The second power transfer unit 44 may include a gear set having a plurality of gears 46. Other power transfer units may also be suitable. The gears 46 transfer torque from the engine 14 to a differential 48 to ultimately provide traction to the vehicle drive wheels 28. The differential 48 may include a plurality of gears that enable the transfer of torque to the vehicle drive wheels 28. In a non-limiting embodiment, the second power transfer unit 44 is mechanically coupled to an axle 50 through the differential 48 to distribute torque to the vehicle drive wheels 28.

The motor 22 can also be employed to drive the vehicle drive wheels 28 by outputting torque to a shaft 52 that is also connected to the second power transfer unit 44.

The battery pack 24 is an exemplary electrified vehicle battery. The battery pack 24 may be a high voltage traction battery that includes a plurality of battery arrays 25 (i.e., battery assemblies or groupings of battery cells) capable of outputting electrical power to operate the motor 22, the generator 18, and/or other electrical loads of the electrified vehicle 12 for providing power to propel the wheels 28. Other types of energy storage devices and/or output devices could also be used to electrically power the electrified vehicle 12.

In an embodiment, the electrified vehicle 12 has two basic operating modes. The electrified vehicle 12 may operate in an Electric Vehicle (EV) mode where the motor 22 is used (generally without assistance from the engine 14) for vehicle propulsion, thereby depleting the battery pack 24 state of charge up to its maximum allowable discharging rate under certain driving patterns/cycles. The EV mode is an example of a charge depleting mode of operation for the electrified vehicle 12. The engine 14 is generally OFF under a default EV mode but could be operated as necessary based on a vehicle system state or as permitted by the operator.

The electrified vehicle 12 may additionally operate in a Hybrid (HEV) mode in which the engine 14 and the motor 22 are both used for vehicle propulsion. The HEV mode is an example of a charge sustaining mode of operation for the electrified vehicle 12. During the HEV mode, the electrified vehicle 12 may reduce the motor 22 propulsion usage in order to maintain the state of charge of the battery pack 24 at a constant or approximately constant level by increasing the engine 14 propulsion. The electrified vehicle 12 may be operated in other operating modes in addition to the EV and HEV modes within the scope of this disclosure.

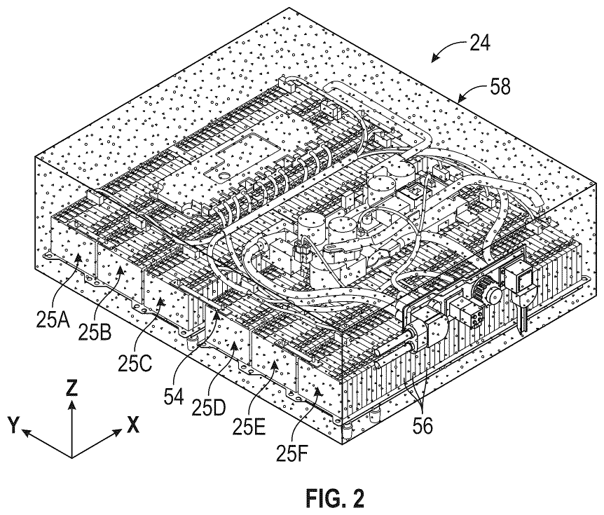

FIG. 2 schematically illustrates a battery pack 24 that can be employed within an electrified vehicle. For example, the battery pack 24 could be incorporated as part of the powertrain 10 of the electrified vehicle 12 of FIG. 1. FIG. 2 is an assembled, perspective view of the battery pack 24.

The battery pack 24 may include a battery system 54. The battery system 54 of the battery pack 24 includes a plurality of battery cells 56 that store energy for powering various electrical loads of the electrified vehicle 12. The battery system 54 could include any number of battery cells within the scope of this disclosure. Therefore, this disclosure is not limited to the exact battery system configuration shown in the drawings.

The battery cells 56 may be stacked side-by-side to construct a grouping of battery cells 56, sometimes referred to as a battery array. In an embodiment, the battery cells 56 are prismatic, lithium-ion cells.

The battery system 54 depicted in FIG. 2 includes a first battery array 25A, a second battery array 25B, a third battery array 25C, a fourth battery array 25D, a fifth battery array 25E, and a sixth battery array 25F. The arrays 25A-25F are arranged within an enclosure 58. Although the battery system 54 is depicted as including six battery arrays, the battery pack 24 could include a greater or fewer number of battery arrays and still fall within the scope of this disclosure.

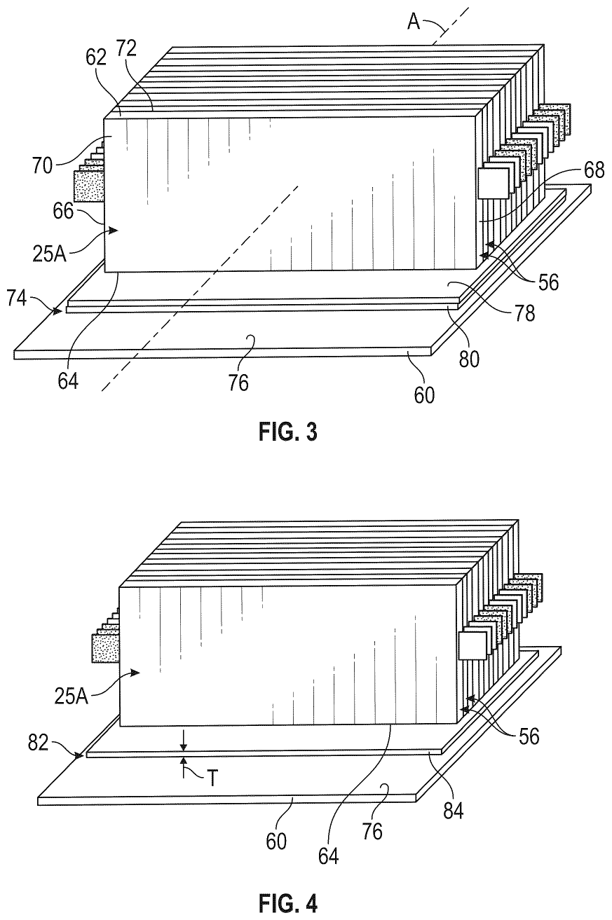

FIG. 3 illustrates an arrangement of the first battery array 25A relative to a thermal exchange plate 60. It should be understood that any additional arrays of the battery pack 24 may be arranged similarly.

The thermal exchange plate 60 may be part of the enclosure 58, or may be a component separate from the enclosure 58. The battery cells 56 of the first battery array 25A are distributed along a longitudinal axis A. Each battery cell 56, in this example, exhibits a housing including a top wall 62, a bottom wall 64, side walls 66, 68 lying in planes substantially parallel to the axis A, and end walls 70, 72 lying in planes substantially perpendicular to the axis A. The terms “top”and “bottom”are used with reference to the orientation of FIG. 3.

In this example, the thermal exchange plate 60 is spaced-apart in a downward direction relative to the first battery array 25A, and is specifically spaced-apart in a downward direction relative to bottom walls 64 of the battery cells 56. The term “downward” is used with reference to the orientation of FIG. 3.

The thermal exchange plate 60 is configured as a cold plate or a portion of a cold plate assembly in one example. The thermal exchange plate 60 could be configured as a heat plate, alternatively. The thermal exchange plate 60 may be part of a liquid cooling system that is associated with the battery system 54 and is configured for thermally managing the battery cells 56 of each battery array.

The battery cells 56 are in close proximity to the thermal exchange plate 60, but are not in direct contact with the thermal exchange plate 60 in this disclosure. Rather, an interface is provided between the battery array 25A and the thermal exchange plate 60. This disclosure includes a number of configurations for the interface, each of which is configured to reduce capacitance between the battery array and the thermal exchange plate 60.

A first interface configuration is represented in FIG. 3. In FIG. 3, an interface 74 is provided between the battery array 25A and the thermal exchange plate 60, and specifically between the bottom walls 64 of the battery cells 56 and a top wall 76 of the thermal exchange plate 60. The top wall 76 of the thermal exchange plate 60 is the wall of the thermal exchange plate 60 directly facing the battery array 25A. While the interface 74 is between the bottom walls 64 and the top wall 76, the thermal exchange plate 60 could be arranged, alternatively or additionally, at a side, end, or top of the battery array 25A, and in that case an interface substantially similar to the interface 74 would be provided in a corresponding location.

The interface 74 includes a layer of thermal interface material (TIM) 78 disposed between the battery array 25A and the thermal exchange plate 60, and in particular between the battery array 25A and the layer of dielectric material 80. The interface 74 further includes the layer of dielectric material 80, which is disposed between the thermal exchange plate 60 and the layer of thermal interface material 78. The layer of dielectric material 80 is, in one example, provided by a coating applied to the thermal exchange plate 60, and in particular applied to the top wall 76. The layer of dielectric material 80 may be provided by a coating of Sipiol®, in an example. The layer of dielectric material 80 may be coated onto the top wall 76 and allowed to cure, such as by UV curing, before the layer of thermal interface material 78 is applied between the layer of dielectric material 80 and the battery array 25A.

The layer of thermal interface material 78 may be made of any known thermally conductive material. In an embodiment, the layer of thermal interface material 78 includes an epoxy resin. In another embodiment, the layer of thermal interface material 78 includes a silicone based material. Other materials, including thermal greases, may alternatively or additionally make up the layer of thermal interface material 78.

A second interface configuration is represented in FIG. 4. In FIG. 4, an interface 82 is provided between the battery array 25A and the thermal exchange plate 60, and specifically between the bottom walls 64 of the battery cells 56 and a top wall 76 of the thermal exchange plate 60. The interface 82 includes a layer of dielectric material 84. In a particular aspect, the interface 82 does not include any layers of thermal interface material (TIM). In a further aspect, the interface 82 consists of the layer of dielectric material 84.

The layer of dielectric material 84 exhibits a thickness T and a dielectric constant (ε) configured to reduce capacitance between the thermal exchange plate 60 and the battery array 25A. In an example, the thickness T is within a range of 25 μm and 250 μm, and the dielectric constant (ε) is less than 3. In another example, the dielectric constant (ε) is within a range of 3 and 7, and the thickness T is greater than 250 μm. Such combinations of thickness T and dielectric constant (ε) have been found to reduce capacitance between the thermal exchange plate 60 and the battery array 25A.

It should be understood that terms such as “about” and “substantially” are not intended to be boundaryless terms, and should be interpreted consistent with the way one skilled in the art would interpret those terms. Directional terms such as “above,” “upper,” “below,” “bottom,” etc., are used with reference to the arrangement of the corresponding components in the drawings and are not intended to otherwise be limiting.

Although the different examples have the specific components shown in the illustrations, embodiments of this disclosure are not limited to those particular combinations. It is possible to use some of the components or features from one of the examples in combination with features or components from another one of the examples.

One of ordinary skill in this art would understand that the above-described embodiments are exemplary and non-limiting. That is, modifications of this disclosure would come within the scope of the claims. Accordingly, the following claims should be studied to determine their true scope and content.

1. A battery pack, comprising:
a battery array;
a thermal exchange plate; and
an interface between the battery array and the thermal exchange plate configured to reduce capacitance between the battery array and the thermal exchange plate.

2. The battery pack as recited in claim 1, wherein the interface includes:
a layer of thermal interface material disposed between the battery array and the thermal exchange plate; and
a layer of dielectric material disposed between the thermal exchange plate and the layer of thermal interface material.

3. The battery pack as recited in claim 2, wherein the layer of dielectric material is a provided by a coating applied to the thermal exchange plate.

4. The battery pack as recited in claim 1, wherein:
the interface includes a layer of dielectric material disposed between the battery array and the thermal exchange plate, and
the layer of dielectric material exhibits a thickness and a dielectric constant configured to reduce capacitance between the battery array and the thermal exchange plate.

5. The battery pack as recited in claim 4, wherein the thickness is within a range of 25 μm and 250 μm, and the dielectric constant is less than 3.

6. The battery pack as recited in claim 4, wherein the dielectric constant is within a range of 3 and 7, and the thickness is greater than 250 μm.

7. The battery pack as recited in claim 4, wherein the layer of dielectric material is a provided by a coating applied to the thermal exchange plate.

8. The battery pack as recited in claim 4, wherein the interface does not include any thermal interface material.

9. The battery pack as recited in claim 4, wherein the interface consists of the layer of dielectric material.

10. The battery pack as recited in claim 1, wherein:
the battery array includes a plurality of battery cells,
each of the plurality of battery cells includes a housing having a bottom wall, and
the interface is between the bottom walls of the battery cells and the thermal exchange plate.

11. The battery pack as recited in claim 1, wherein the battery array is one of a plurality of battery arrays within the battery pack.

12. The battery pack as recited in claim 1, wherein the battery pack is a battery pack of an electrified vehicle.

13. An electrified vehicle, comprising:
a battery pack including a battery array, a thermal exchange plate, and an interface between the battery array and thermal exchange plate, wherein the interface includes either:
(i) a layer of thermal interface material disposed between the battery array and the thermal exchange plate, and a layer of dielectric material disposed between the thermal exchange plate and the layer of thermal interface material, or
(ii) a layer of dielectric material disposed between the battery array and the thermal exchange plate, wherein the layer of dielectric material exhibits a thickness and a dielectric constant according to one of the following: (a) the thickness is within a range of 25 μm and 250 μm, and the dielectric constant is less than 3, or (b) the dielectric constant is within a range of 3 and 7, and the thickness is greater than 250 μm.

14. The electrified vehicle as recited in claim 13, wherein the interface includes:
a layer of thermal interface material disposed between the battery array and the thermal exchange plate; and
a layer of dielectric material disposed between the thermal exchange plate and the layer of thermal interface material.

15. The electrified vehicle as recited in claim 13, wherein:
the interface includes a layer of dielectric material disposed between the battery array and the thermal exchange plate, and
the layer of dielectric material exhibits a thickness within a range of 25 μm and 250 μm and further exhibits a dielectric constant less than 3.

16. The electrified vehicle as recited in claim 13, wherein:
the interface includes a layer of dielectric material disposed between the battery array and the thermal exchange plate, and
the layer of dielectric material the exhibits a dielectric constant within a range of 3 and 7, and further exhibits a thickness greater than 250 μm.

17. The electrified vehicle as recited in claim 13, wherein the interface does not include any thermal interface material.

18. The electrified vehicle as recited in claim 13, wherein the interface consists of the layer of dielectric material.

19. A method, comprising:
establishing an interface between a battery array and a thermal exchange plate, wherein the wherein the interface includes either:
(i) a layer of thermal interface material disposed between the battery array and the thermal exchange plate, and a layer of dielectric material disposed between the thermal exchange plate and the layer of thermal interface material, or
(ii) a layer of dielectric material disposed between the battery array and the thermal exchange plate, wherein the layer of dielectric material exhibits a thickness and a dielectric constant according to one of the following: (a) the thickness is within a range of 25 μm and 250 μm, and the dielectric constant is less than 3, or (b) the dielectric constant is within a range of 3 and 7, and the thickness is greater than 250 μm.

20. The method as recited in claim 19, wherein the interface consists of the layer of dielectric material, and wherein the dielectric layer is provided by a coating applied to the thermal exchange plate.
